(19) United States
(12) Patent Application Publication
(10) Pub. No.: US 2026/0335727 A1
(43) Pub. Date: Oct. 29, 2026

(54) GOLF CLUBS HAVING ORNAMENTAL FEATURES AND METHODS FOR MANUFACTURING THE SAME

(71) Applicant: GOLFYR AG, St. Gallen (CH)

(72) Inventors: Roger STADLER, Rancho Santa Fe, CA (US); Tamara Pizzigoni, Rancho Santa Fe, CA (US)

(21) Appl. No.: 19/385,113

(22) Filed: Nov. 10, 2025

Related U.S. Application Data
(60) Provisional application No. 63/717,994, filed on Nov. 8, 2024.

(51) Int. Cl. A63B 53/04; A63B 53/10; A63B 53/14; B32B 5/02; B32B 5/26

(52) U.S. Cl. CPC A63B 53/0466; A63B 53/0416; A63B 53/10; A63B 53/14; B32B 5/024; B32B 5/263; A63B 53/0433; A63B 2209/023; B32B 2262/106; B32B 2307/412

(57) ABSTRACT

Golf clubs and components of golf clubs are provided herein. A club head comprises a body comprising an inner textile layer defining a cavity within the body, an outer textile layer disposed about at least a portion of the inner textile layer and a designed textile layer disposed about at least a portion of the outer textile layer. The designed textile layer comprises one or more visual features. A resin is infiltrated into the inner textile layer and the outer textile layer to form a composite structure. The textile-based layers allow visual design elements to be integrated directly into the material structure without additional coatings or decals.

### CROSS-REFERENCE TO RELATED APPLICATIONS

This application claims the benefit of U.S. Provisional Application Serial No. 63/717,994, filed Nov.8, 2024, the complete disclosure of which is incorporated herein by reference.

### TECHNICAL FIELD

This following description generally relates to golf clubs. Specifically, the present disclosure relates to golf clubs and/or components thereof fabricated from carbon fibers and including ornamental features.

### BACKGROUND

Golf is a centuries old sport in which players use various clubs to hit a ball into a series of holes on a course in as few strokes as possible. The popularity of golf continues to surge each year, with now over 66 million golfers in the world. Thus, there continues to be a desire for improvements to golf clubs, balls and related products.

Conventional “woods” or “wood-type” clubs (e.g., drivers, fairway woods, utility/hybrid clubs, etc.) are often manufactured from relatively strong, lightweight metals, such as titanium, steel, aluminum, or alloys thereof. Titanium and titanium alloys are particularly preferred due to their relatively higher strength and lower density as compared to other metals and alloys, such as steel. Titanium, however, may often be cost prohibitive as compared to the other metals and alloys. As such, as club heads of wood-type clubs increase to provide larger “sweet spots,” the cost of materials and manufacture also increases.

In view of the foregoing, the club heads of wood-type clubs may often be at least partially fabricated from carbon fibers and composites thereof, such as carbon fiber reinforced epoxy. While carbon fibers and carbon fiber composites are relatively lighter than steel, club heads manufactured therefrom may often suffer from durability issues, and the methods of manufacturing the club heads from carbon fibers are often associated with increased costs. Additionally, club heads manufactured from carbon fibers are generally limited in their visual features (e.g., alignment features, logos, brands, patterns, ornaments).

There is a desire to provide more options for users to customize their clubs. What is needed, then, are lightweight, durable club heads fabricated from carbon fibers that may be manufactured with one or more ornamental features to allow customization and provide an aesthetically preferred appearance to the club.

### SUMMARY

This following is intended merely to introduce a simplified summary of some aspects of one or more embodiments of the subject matter discussed herein. Further areas of applicability of the subject matter will become apparent from the detailed description provided hereinafter. This summary is not an extensive overview, nor is it intended to identify key or critical elements of the present teachings, nor to delineate the scope of the subject matter. Rather, its purpose is merely to present one or more concepts in simplified form as a prelude to the detailed description below.

Golf clubs, components of golf clubs and methods for manufacturing these components are provided herein. The golf clubs and/or components thereof are fabricated from non-metallic fibers and include ornamental or visual features that allow for individual customization of the clubs.

In one aspect, a club head comprises a body including an inner textile layer defining a cavity within the body, an outer textile layer disposed about at least a portion of the inner textile layer, and a designed textile layer disposed about at least a portion of the outer textile layer. The designed textile layer comprises one or more visual features. The club head further comprises a resin infiltrated into the inner textile layer and the outer textile layer to form a composite structure.

In some embodiments, the resin is infiltrated into the designed textile layer. The resin binds the designed textile layer to the outer textile layer, and the outer textile layer to the inner textile layer. In an exemplary embodiment, the inner and outer textile layers and the designed textile layer are saturated with the resin.

In some embodiments, the body is free, or substantially free, of metal and metal alloys. The resin infiltrates and wets the textile layers to form a composite structure having sufficient strength and stiffness to withstand repeated impact with a golf ball during normal play.

The composite club head structure described herein provides several advantages over conventional metallic club heads. By forming the body from multiple textile layers infiltrated with a resin, the overall mass of the club head can be substantially reduced while maintaining sufficient stiffness and durability for repeated impact with a golf ball. The reduced mass enables redistribution of weight within the head to achieve a desired center of gravity and moment of inertia, thereby enhancing forgiveness and playability. In addition, the composite material provides inherent vibration damping, which improves sound and feel upon impact compared to metallic constructions. The textile-based layers also allow visual design elements to be integrated directly into the material structure without additional coatings or decals.

In some embodiments, the inner and outer textile layers comprise one or more non-metallic fibers, such as carbon fibers, glass fibers, aramid fibers, or other high-strength polymeric fibers. The fibers may be arranged in a woven, non-woven, knitted, or stitched mat. In an exemplary embodiment, the inner and outer textile layers consist of carbon fibers. The designed textile layer may also consist of carbon fibers or other non-metallic fibers.

The resin may include, but is not limited to, an epoxy, a vinyl ester, phenolics, thermoplastic polyurethane, thermoplastic polypropylene, thermoplastic polyethylene, thermoplastic polyether ether ketone (PEEK), thermoplastic polyesters, thermoplastic polystyrenes, thermoplastic polycarbonates, thermoplastic polyvinylchlorides, nylon, thermoplastic polymethylmethacrylate, thermoset polyurea, thermoset polyurethanes, polyamides, polyketones, polyesters, copolyesters, polyphenylene sulfide, polyolefins, polyarylates, polyphenylene ethers, or the like, or any combination thereof.

In some embodiments, the resin comprises a substantially optically transparent material. In other embodiments, the resin may include colorants, pigments, or other additives such that the resin is opaque or tinted.

In some embodiments, the club head may comprise a face plate disposed at and coupled with a forward portion of the body. The club head may also comprise a sole plate disposed at and coupled with a bottom portion of the body.

In some embodiments, the one or more visual features of the designed textile layer can comprise one or more of an alignment feature, a logo, a brand name, an aesthetic pattern, artwork, an ornamental element, or any combination thereof.

In another aspect, a golf club comprises a club head, a shaft and a grip. The shaft comprises a shaft body including an inner textile layer defining a cavity within the body, an outer textile layer disposed about at least a portion of the inner textile layer and a designed textile layer disposed about at least a portion of the outer textile layer. The designed textile layer comprises one or more visual features. The club head further comprises a resin infiltrated into the inner textile layer and the outer textile layer to form a composite structure.

In some embodiments, the grip comprises a grip body including an inner textile layer defining a cavity within the body, an outer textile layer disposed about at least a portion of the inner textile layer, and a designed textile layer disposed about at least a portion of the outer textile layer. The designed textile layer comprises one or more visual features. The club head further comprises a resin infiltrated into the inner textile layer and the outer textile layer to form a composite structure.

In some embodiments, the club head comprises a body including an inner textile layer defining a cavity within the body, an outer textile layer disposed about at least a portion of the inner textile layer and a designed textile layer disposed about at least a portion of the outer textile layer. The designed textile layer comprises one or more visual features. The club head further comprises a resin infiltrated into the inner textile layer and the outer textile layer to form a composite structure.

In another aspect, a method for fabricating a club head is provided. The method comprises preparing a sacrificial core, disposing an inner textile layer around the core, disposing an outer textile layer around at least a portion of the inner textile layer, disposing a designed textile layer around at least a portion of the outer textile layer, the designed textile layer comprising one or more visual features, and infiltrating the inner and outer textile layers with a resin to form a composite structure.

In some embodiments, the method further comprises saturating the inner and outer textile layers with the resin.

In some embodiments, the method further comprises injecting a curable resin into a mold cavity under pressure to impregnate the inner and outer textile layers, and curing the resin to form the composite body.

In some embodiments, the method may further comprise removing the sacrificial core from the body of the club head.

In some embodiments, the inner and outer textile layers comprise one or more non-metallic fibers, such as carbon fibers, glass fibers, aramid fibers, or other high-strength polymeric fibers. The fibers may be arranged in a woven, non-woven, knitted, or stitched mat. In an exemplary embodiment, the inner and outer textile layers consist of carbon fibers. The designed textile layer may also consist of carbon fibers or other non-metallic fibers.

The resin may include, but is not limited to, an epoxy, a vinyl ester, phenolics, thermoplastic polyurethane, thermoplastic polypropylene, thermoplastic polyethylene, thermoplastic polyether ether ketone (PEEK), thermoplastic polyesters, thermoplastic polystyrenes, thermoplastic polycarbonates, thermoplastic polyvinylchlorides, nylon, thermoplastic polymethylmethacrylate, thermoset polyurea, thermoset polyurethanes, polyamides, polyketones, polyesters, copolyesters, polyphenylene sulfide, polyolefins, polyarylates, polyphenylene ethers, or the like, or any combination thereof.

In some embodiments, the resin comprises a substantially optically transparent material. In other embodiments, the resin may include colorants, pigments, or other additives such that the resin is opaque or tinted.

In some embodiments, the layer structure may be disposed about the sacrificial core through a variety of different processes, including but not limited to, additive manufacturing (3D), Vacuum-Assisted Resin Transfer Molding (VARTM/VRTM), compression molding, autoclave molding, filament winding, and resin transfer molding. In an exemplary embodiment, the layer structure is disposed about the sacrificial core though an RTM process.

In some embodiments, the method may further comprise disposing and coupling a face plate with a forward portion of the body.

In some embodiments, the method may further comprise disposing and coupling a sole plate with a bottom portion of the body.

In some embodiments, the one or more visual features of the designed textile layer can comprise one or more of an alignment feature, a logo, a brand name, an aesthetic pattern, artwork, an ornamental element, or any combination thereof.

In some embodiments, the one or more visual features of the designed textile layer may be selected from the group consisting of an alignment feature, a logo, a brand name, an aesthetic pattern, artwork, an ornamental element, any combinations thereof.

In some embodiments, the step of disposing the plurality of textile layers about the sacrificial core can comprise disposing a first textile layer directly adjacent the sacrificial core, and disposing a second textile layer directly adjacent the first textile layer, wherein respective fibers of the first textile layer and respective fibers of the second textile layer are directionally offset with respect to one another.

In some embodiments, the step of disposing the plurality of textile layers about the sacrificial core can comprise disposing a first textile layer directly adjacent the sacrificial core, and disposing a second textile layer directly adjacent the first textile layer, wherein respective fibers of the first textile layer and respective fibers of the second textile layer are aligned or substantially aligned with one another.

In still another aspect, sports equipment, gear or wearable items are provided that comprises one or more textile layers and an outer designed textile layer, such as those described herein. The sports equipment, gear or wearable items may include, but are not limited to, balls, bats, rackets, clubs, sticks, helmets, pads, guards, gloves, footwear, uniforms, jerseys, hats, visors, headbands, wristbands, equipment bags or cases, training or fitness gear, skis, boards, bicycles, boats, kayaks and the like.

Further areas of applicability of the subject matter will become apparent from the detailed description provided hereinafter. It should be understood that the detailed description and specific examples, while indicating some typical aspects of the subject matter, are intended for purposes of illustration only and are not intended to limit the scope thereof.

The recitation herein of desirable objects which may be met by various embodiments of the present description is not meant to imply or suggest that any or all of these objects may be present as essential features, either individually or collectively, in the most general embodiment of the present description or any of its more specific embodiments.

### BRIEF DESCRIPTION OF THE DRAWINGS

The accompanying drawings, which are incorporated in and constitute a part of this specification, illustrate several embodiments of the subject matter and, together with the description, serve to explain the principles thereof.

FIG. 1 is a perspective view of a golf club head;

FIGS. 2A—2E illustrate a schematic of a method for manufacturing the club head of FIG. 1;

FIGS. 3A—3E illustrate schematic cross-sectional views of FIGS. 2A—2E;

FIG. 4 is a perspective view of a golf club head; and

FIG. 5 is a perspective view of a golf club.

### DETAILED DESCRIPTION

This description and the accompanying drawings illustrate exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

As used throughout, ranges are used as shorthand for describing each and every value that is within the range. It should be appreciated and understood that the description in a range format is merely for convenience and brevity and should not be construed as an inflexible limitation on the scope of any embodiments or embodiments discussed herein. Accordingly, the range should be construed to have specifically included all the possible subranges as well as individual numerical values within that range. As such, any value within the range may be selected as the terminus of the range. For example, description of a range such as from 1 to 5 should be considered to have specifically included subranges such as from 1.5 to 3, from 1 to 4.5, from 2 to 5, from 3.1 to 5, etc., as well as individual numbers within that range, for example, 1, 2, 3, 3.2, 4, 5, etc. This applies regardless of the breadth of the range.

Additionally, all numerical values are “about” or “approximately” the indicated value, and consider experimental error and variations that would be expected by a person having ordinary skill in the art. It should be appreciated that all numerical values and ranges discussed herein are approximate values and ranges, whether “about” is used in conjunction therewith. It should also be appreciated that the term “about,” as used herein, in conjunction with a numeral refers to a value that may be ± 0.01% (inclusive), ± 0.1% (inclusive), ± 0.5% (inclusive), ± 1% (inclusive) of that numeral, ± 2% (inclusive) of that numeral, ± 3% (inclusive) of that numeral, ± 5% (inclusive) of that numeral, ± 10% (inclusive) of that numeral, or ± 15% (inclusive) of that numeral. It should further be appreciated that when a numerical range is discussed herein, any numerical value falling within the range is also specifically included.

As used herein, “free” or “substantially free” of a material may refer to a composition, component, or phase where the material is present in an amount of less than 10.0 wt%, less than 5.0 wt%, less than 3.0 wt%, less than 1.0 wt%, less than 0.1 wt%, less than 0.05 wt%, less than 0.01 wt%, less than 0.005 wt%, or less than 0.0001 wt% based on a total weight of the composition, component, or phase.

All references cited herein are hereby incorporated by reference in their entireties. In the event of a conflict in a definition with a cited reference, the present teachings control.

Golf clubs and one or more components thereof (e.g., club head, shaft, grip etc.) and methods for manufacturing the same are described herein. While the following describes golf clubs or club heads thereof in the context of a wood-type golf club, it should be appreciated that the designs, principles, and methods discussed are equally applicable in whole or in part to all golf clubs and components (e.g., shafts) thereof including, but not limited to, fairway woods, utility clubs, hybrid clubs, irons, the shafts thereof, the grips thereof, or the like, or any combination thereof. Further, it is understood that the designs, principles, and methods discussed herein apply to other sports equipment, gear or wearable items and that such other sports equipment, gear or wearable items can comprise one or more textile layers and an outer designed textile layer, as will be described in greater detail in reference to golf clubs below.

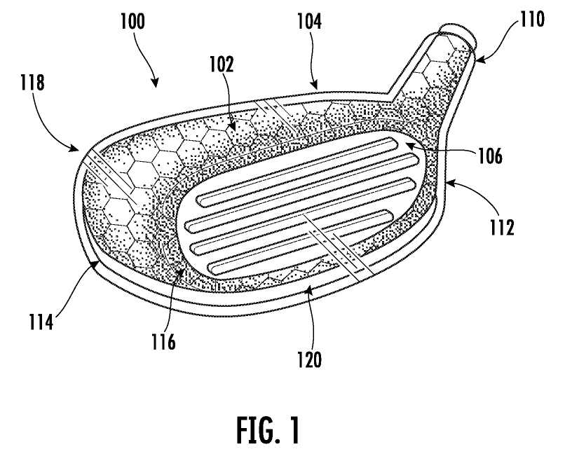

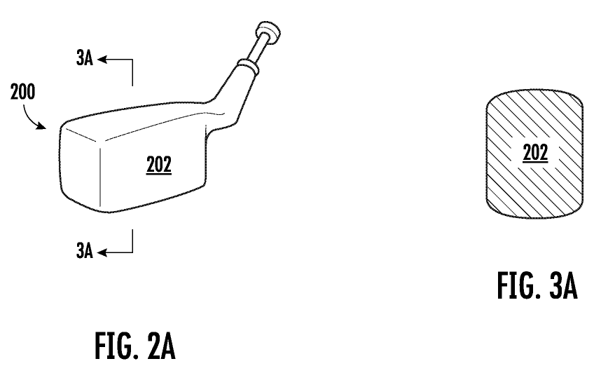

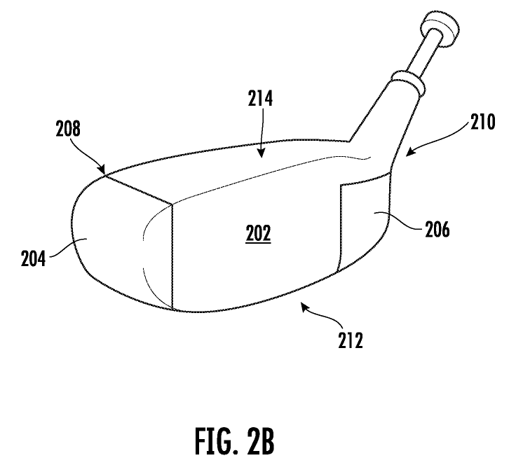

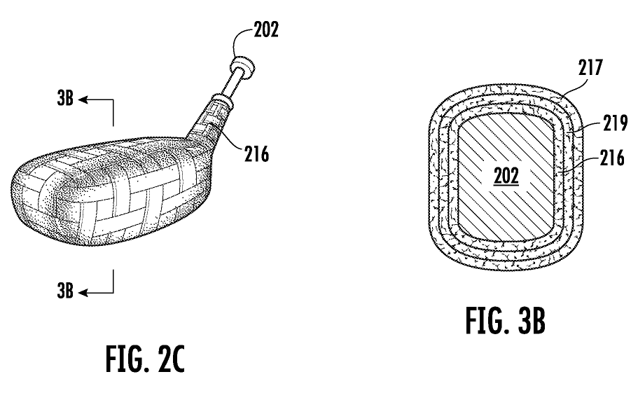

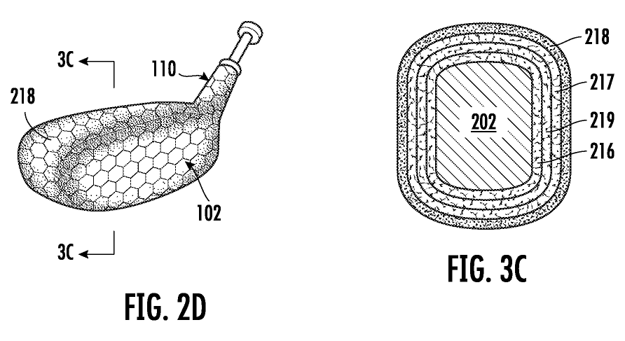

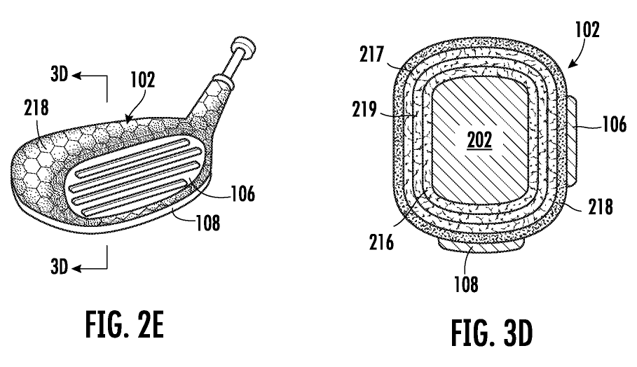

FIG. 1 is perspective view of an exemplary club head 100 including one or more visual features 102. The club head 100 may include a body 104, a face or impact plate 106, a sole plate or insert 108, a hosel 110, the one or more visual features 102, or a combination thereof. For example, as illustrated in FIG. 1, the club head 100 includes the body 104, the face plate 106, the sole plate 108 (see FIG. 2E), and the hosel 110 coupled with one another. The body 104 may define a heel portion 112 disposed proximal the hosel 110 of the club head 100 and a toe portion 114 disposed distal or opposite the heel portion 112. The hosel 110 may extend from the heel portion 112 of the club head 100. While FIG. 1 illustrates the hosel 110 as being integrally formed with the body 104, it should be appreciated that the hosel 110 may be a separate component coupled directly or indirectly with the body 104. The hosel 110 may be capable of, or configured to, receive or be coupled with a shaft (not shown) of a golf club. The body 104 may further define a forward portion 116 and a rear portion 118 disposed distal or opposite the forward portion 116. As illustrated in FIG. 1, the face plate 106 may be disposed at or proximal the forward portion 116 of the body 104 and coupled therewith. As further illustrated in FIG. 1, the sole plate 108 may be disposed at or proximal a bottom portion 120 of the body 104 and coupled therewith.

The one or more visual features 102 of the club head 100 may be disposed on or about at least a portion of the body 104. For example, as illustrated in FIG. 1, the visual features 102 (e.g., a hexagonal or honeycomb design) may be disposed on or about the toe portion 114, the heel portion 112, the rear portion 118, the bottom portion 120, a top portion, and/or the forward portion 116 of the body 104. As further discussed herein, the one or more visual features 102 may be provided by one or more ornamental elements, woven fabrics or textiles, non-woven fabrics or textiles, or the like, or any combination thereof.

Visual features 102 may include, but are not limited to, alignment features (e.g., ball/club alignment features), logos, brand names (e.g., GUCCI®, DIOR®, ROLEX®, etc. by way of non-limiting examples only), aesthetic patterns, artwork, ornamental elements (e.g., beads, sequins, piping, crystals, embroidery, etc.), rhinestones, particles, textiles (e.g., designed textiles), precious stones, semiprecious stones, skins, prints, 2-dimensional (2-D) synthetic or natural materials, 3-D synthetic or natural materials, textures, or the like, or any combination thereof.

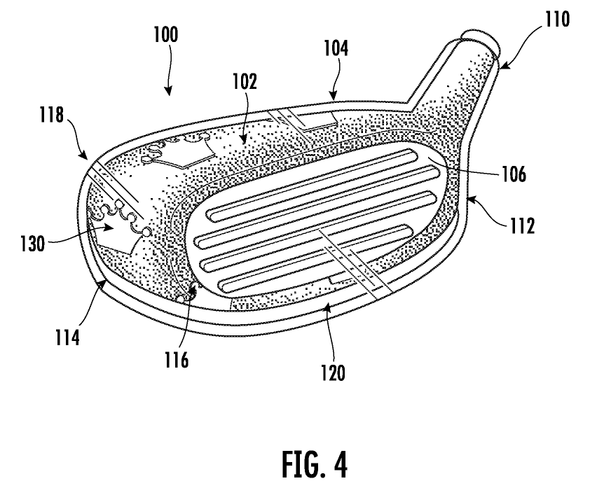

In some embodiments, the club head 100 may include one or more additional visual features 130 in combination with visual features 102. As shown in FIG. 4, club head 100 includes a basic visual layer 102 that may, for example have a pattern, such as a honeycomb, hexagonal or other pattern, and one or more additional visual features 130 spaced throughout layer 102. These additional features 130 may, for example, include a logo, brand name, or other pattern that, for example, identifies the manufacturer and/or sponsor of the club.

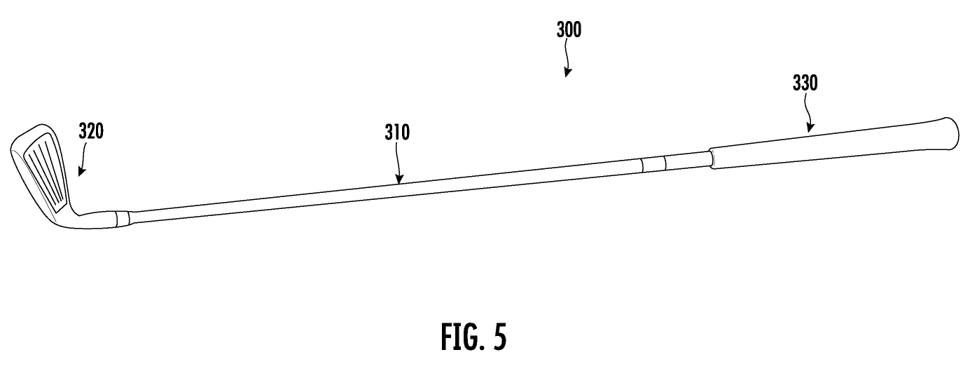

FIG. 5 illustrates a golf club 300 comprising a club head 320, a shaft 310 coupled to the club head 320 and a grip 330 that may be coupled to the shaft 310, or disposed about a portion of the shaft 310. Similar to the club head described above, shaft 310 and/or grip 330 may include one or more visual features (not shown), such as alignment features (e.g., ball/club alignment features), logos, brand names (e.g., GUCCI®, DIOR®, ROLEX®, etc.), aesthetic patterns, artwork, ornamental elements (e.g., beads, sequins, piping, crystals, embroidery, etc.), rhinestones, particles, textiles (e.g., designed textiles), precious stones, semiprecious stones, skins, prints, 2-dimensional (2-D) synthetic or natural materials, 3-D synthetic or natural materials, textures, or the like, or any combination thereof.

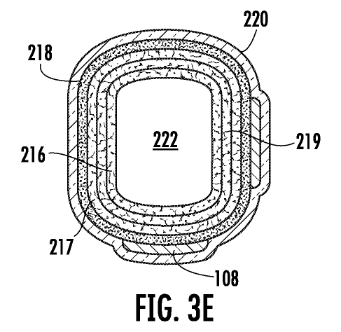

As shown in FIGS. 3B—3E, the golf club head, the shaft and/or the grip described above comprise an inner textile layer 216 defining a cavity 222 within the body, an outer textile layer 217 disposed about at least a portion of the inner textile layer 216 and a designed textile layer 218 disposed about at least a portion of the outer textile layer 217. The designed textile layer 218 comprises one or more visual features, as discussed above. The club head further comprises a resin (not shown) infiltrated into the inner textile layer 216 and the outer textile layer 217 to form a composite structure. In some embodiments, the body further includes a third textile layer 219 disposed between inner and outer textile layers 216, 217. In other embodiments, the body may include a fourth, fifth or more textile layers disposed within inner and outer textile layers 216, 217.

In some embodiments, the resin is infiltrated into the designed textile layer 218. The resin binds the designed textile layer 218 to the outer textile layer 217 and the outer textile layer 217 to the inner textile layer 216 (and/or any other textile layers 219 disposed between inner and outer textile layers 216, 217). In an exemplary embodiment, the inner and outer textile layers 216, 217 and the designed textile layer 218 are saturated with the resin.

In some embodiments, the body is free or substantially free of metal and metal alloys. The resin infiltrates and wets the textile layers to form a composite structure having sufficient strength and stiffness to withstand repeated impact with a golf ball during normal play.

In some embodiments, the inner and outer textile layers 216, 217 and/or the designed textile layer 218 comprise one or more non-metallic fibers, such as carbon fibers, glass fibers, aramid fibers, or other high-strength polymeric fibers. The fibers may be arranged in a woven, non-woven, knitted, or stitched mat. In an exemplary embodiment, the inner and outer textile layers consist of carbon fibers. The designed textile layer may also consist of carbon fibers or other non-metallic fibers.

The resin may include, but is not limited to, an epoxy, a vinyl ester, phenolics, thermoplastic polyurethane, thermoplastic polypropylene, thermoplastic polyethylene, thermoplastic polyether ether ketone (PEEK), thermoplastic polyesters, thermoplastic polystyrenes, thermoplastic polycarbonates, thermoplastic polyvinylchlorides, nylon, thermoplastic polymethylmethacrylate, thermoset polyurea, thermoset polyurethanes, polyamides, polyketones, polyesters, copolyesters, polyphenylene sulfide, polyolefins, polyarylates, polyphenylene ethers, or the like, or any combination thereof.

In some embodiments, the resin comprises a substantially optically transparent material. In other embodiments, the resin may include colorants, pigments, or other additives such that the resin is opaque or tinted.

In addition, sports equipment, gear or wearable items are provided that comprises one or more textile layers and an outer designed textile layer, such as those described herein. The sports equipment, gear or wearable items may include, but are not limited to, balls, bats, rackets, clubs, sticks, helmets, pads, guards, gloves, footwear, uniforms, jerseys, hats, visors, headbands, wristbands, equipment bags or cases, training or fitness gear, skis, boards, bicycles, boats, kayaks and the like.

FIGS. 2A—2E illustrate a schematic of an exemplary process or method for manufacturing the club head 100 of FIG. 1 (and/or club shaft 310 and grip 330 of FIG. 5). FIGS. 3A—3E illustrate schematic cross-sectional views of FIGS. 2A—2E, respectively.

The method may include preparing or manufacturing a sacrificial core 202, as illustrated in FIGS. 2A and 3A. Preparing or manufacturing the sacrificial core 202 may include fabricating a mold having a predetermined shape and size, and disposing a sacrificial material in the mold to form the sacrificial core 202 having the predetermined shape and size. The shape and/or size of the sacrificial core 202 may be determined, at least in part, by a final shape and/or size of the club head 100 or the body 104 thereof. The sacrificial core 202 may include or be prepared from any sacrificial material capable of or configured to be removed after forming, preparing, or otherwise manufacturing the club head 100 or the body 104 thereof. For example, the sacrificial core 202 may include or be prepared from a sacrificial material capable of or configured to be removed via heating (e.g., melting), dissolution in a solvent (e.g., water, alcohol, organic solvent, etc.), or the like, or any combination thereof. Illustrative sacrificial materials may be or include, but are not limited to, a wax, a sacrificial polymer, a resin, or the like, or any combination thereof. Illustrative sacrificial polymers may be or include, but are not limited to, polylactic acid (PLA), polyacrylic acid, or the like, or any combination thereof.

The method may also include disposing or temporarily coupling one or more weighting elements (two are shown 204, 206) with the sacrificial core 202, as illustrated in FIG. 2B. For example, as illustrated in FIG. 2B, a first or toe weighting element 204 may be disposed or coupled with a first end portion 208 of the sacrificial core 202, and a second or heel weighting element 206 may be disposed or coupled with a second end portion 210 of the sacrificial core 202. The shape and/or size of the toe and heel weighting elements 204, 206 may be determined, at least in part, by the shape and/or size of the toe and heel portions 112, 114 of the body 104. While FIG. 2B illustrates the weighting elements 204, 206 at the first and second end portions 208, 210 of the sacrificial core 202, it should be appreciated that the weighting elements 204, 206 or additional weighting elements (not shown) may be disposed at or about other locations. For example, a weighting element (not shown) may be disposed at or about a bottom portion or underside 212 and/or a top portion or topside 214 of the sacrificial core 202. Each of the weighting elements 204, 206 may be capable of or configured to at least partially influence the weight distribution of the club head 100. Each of the weighting elements 204, 206 may include or be prepared from one or more metals and/or alloys. Exemplary metals and/or alloys may be or include, but are not limited to, steel, lead, tungsten, titanium, copper, tin, aluminum, or the like, or any combination thereof. In at least one embodiment, the body 104 of the club head 100 may be manufactured without any one or more of the weighting elements 204, 206. For example, the body 104 may be fabricated separately from the weighting elements 204, 206, and the weighting elements 204, 206 may be detachably coupled with the body 104 to at least partially customize the club head 100.

The method may also include disposing one or more textile layers or structural textile layers 216, 217, 219 about at least a portion of the sacrificial body 202 and/or the weighting elements 204, 206, as illustrated in FIGS. 2C and 3B. Each of the textile layers 216, 217, 219 may be pre-formed or precut and sized to fit about the sacrificial body 202 and/or the weighting elements 204, 206. The textile layers 216, 217, 219 may be formed or cut with a predetermined size, dimension, and/or shape to meet specific specifications of the club head 100. The size, dimension, and/or shape of the preformed/precut textile layers 216, 217, 219 may be determined, at least in part, on the properties (e.g., type, size, shape, etc.) of the club head 100, and may be determined with predetermined calculations. In one embodiment, the textile layers 216, 217, 219 may be ultrasonically cut via conventional processes. While FIG. 2C illustrates three textile layers 216, 217, 219, it should be appreciated that any number of textile layers may be utilized. For example, the club head 100 may include about 5, about 10, about 20, about 30, about 40, about 50, or 60 to about 70, about 75, about 80, about 85, about 90, about 95, about 100 of the textile layers 216.

The textile layers 216, 217, 219 may be or may include mats of woven and/or non-woven fibers. The fibers of the textile layers 216, 217, 219 may be or include fibers prepared from one or more alloys, metals, polymers, carbon, or the like, or any combination thereof. Illustrative fibers may be or include, but are not limited to, fiber-reinforced plastic, carbon fibers, carbon fiber reinforced polymer, metallic fibers, glass fibers, ceramic fibers, aramid, Kevlar fibers, or the like, or any combination thereof. In at least one embodiment, one or more of the textile layers 216, 217, 219 may include a composite material. The composite material may include a reinforcing material (e.g., fibers) and a matrix material (e.g., polymer). Illustrative fibers of the composite material may be or include any one or more of the fibers disclosed herein. Illustrative matrix materials may be or include, but are not limited to, a polymer, a copolymer, a thermoplastic material, a thermoset, a resin, or the like, or any combination thereof. The matrix can infiltrate between the layers and also “wettens” the layers itself, in a similar manner to how you would dip a textile into water. This gives the composite material the required strength.

The fibers of any one or more of the textile layers 216, 217, 219 may be disposed unidirectionally such that the fibers may be aligned or substantially aligned with one another. The fibers of any one or more of the textile layers 216 may also be disposed in a multidirectional orientation. For example, a first portion of the fibers of the textile layers 216 may be disposed in a first direction, and a second portion of the fibers may be disposed in a second direction different than (e.g., orthogonal to) the first direction. In at least one embodiment, the fibers of any one or more of the textile layers may be disposed or arranged in a weave pattern. Illustrative weave patterns of the textile layers may be or include, but are not limited to, one or more of a plain weave pattern, a twill weave pattern, a satin weave pattern, a harness-satin weave pattern, a triaxial weave pattern, a jacquard weave pattern, an aquarius weave pattern, a constellation weave pattern, a galaxy weave pattern, a rook weave pattern, an atomic weave pattern, a wasp weave pattern, a roswell weave pattern, a labyrinth weave pattern, or the like, or any combination thereof. It should be appreciated that each of the textile layers 216, 217, 219 may independently be or include woven fibers or non-woven fibers. For example, a first textile layer 216 may be or include woven fibers, and a second textile layer 217 may be or include non-woven fibers. Further, a first textile layer 216 may have the same or different weave pattern than a second textile layer 217. Similarly, a first textile layer 216 may have unidirectional fibers, and a second textile layer 217 may have unidirectional fibers rotationally offset from the fibers of the first textile layer 216. In an exemplary embodiment, illustrated in FIGS. 2C and 3C, the one or more textile layers 216, 217, 219 are woven mats of carbon fibers.

The orientation and/or arrangement of any one or more of the textile layers 216, 217, 219 and/or the fibers thereof may be predetermined and/or customized such that the resulting club head 100 provides particular performance features and/or properties. In particular, the layers are arranged in such a way that the mechanical performance is maximized for outcome of the club-swing hitting the ball and the club-head withstanding all the forces applied without sustaining any damage. For example, each of the one or more textile layers 216, 217, 219 or the fibers thereof may be independently selected for any of the foregoing options (e.g., unidirectional, multidirectional, weave pattern, orientation, etc.) to provide the club head 100 with improved weight distribution, improved elasticity, improved swing dynamics, improved impact dynamics, improved sound quality (e.g., from impact with the ball), improved durability, improved deformation resistance, improved power, improved aerodynamics, or the like, or any combination thereof.

The carbon textile layers (multidirectional preprag) can be placed in such a way that the mechanical properties ensure the performance of the golf club. For instance, they can be arranged in layers, enforcing certain parts of the golf clubs with the highest impact to make sure the structure is not damaged at the moment of the golf ball impact. In an exemplary embodiment, the outer layer, the textile layer, can, but is not limited to, being mostly decorative. These outer layers can consist of any type of decorative, fashion, textile (jeans textile, etc.), embroidery, sequins combinations, and many more. These outer layers can be covered with the resin “gluing” these layers to the more inner layers while also protecting the outer most layer. This protective matrix material (resin) can be transparent, but can also be colored, glittery, metallic, etc.

The method may also include disposing one or more of the visual features 102 about at least a portion of the textile layers 216, 217, 219, as illustrated in FIGS. 2D and 3D. The visual features 102 may be or include, but are not limited to, alignment features (e.g., ball/club alignment features), logos, brand names (e.g., GUCCI®, DIOR®, ROLEX®, etc. by way of non-limiting examples only), aesthetic patterns, artwork, ornamental elements (e.g., beads, sequins, piping, crystals, embroidery, etc.), rhinestones, particles, textiles (e.g., designed textiles), precious stones, semiprecious stones, skins, prints, 2-dimensional (2-D) synthetic or natural materials, 3-D synthetic or natural materials, textures, or the like, or any combination thereof. These brand names, logos, or patterns can also laser engraved into the cavity by forming the liquid resin in the brand name, logo or pattern such that, after consolidation, the visual features are visible on the surface of the club.

In an exemplary embodiment, illustrated in FIGS. 2D and 3C, the visual features 102 may be from or provided by at least one designer or fashion textile layer or sheet 218. The designed textile 218 of FIG. 2D includes a honeycomb (i.e., a repeating hexagonal design), which is merely demonstrative and shown for ease of explaining the concept. This repeating hexagonal design may be embroidered onto the designed textile 218, as an illustration of one embodiment. The repeating hexagonal design may also be ink transferred onto the designed textile 218, in another exemplary embodiment. In another exemplary embodiment, the design or pattern to be achieved can be engraved into the cavity that forms the liquid resin, such as by laser engraving or etching into the cavity. This would create a design or pattern visible on the outer surface that can display a desired logo, brand name, etc.

It should be appreciated that the designed textile 218 may have any number of designs and/or colors. For example, the designed textile 218 may include a repeating design, a logo, a brand name, or any combination thereof. In at least one embodiment, the designed textile layer or sheet 218 may not significantly contribute to the structural features of the club head 100. For example, the designed textile 218 may only contribute design and visual attributes to the club head 100. In another example, the designed textile layer or sheet 218 may contribute the same or substantially the same structural features or properties to the club head 100 as the structural textile layers 216.

The method may also include disposing and coupling the face plate 106 and/or the sole plate (not shown) to the forward portion 116 and/or the bottom portion 120 of the body 104, respectively, as illustrated in FIGS. 2E and 3E. The face plate 106 and the sole plate may be coupled with the body 104 via any suitable conventional process. For example, the face plate 106 and the sole plate 108 may be coupled with textile layer 216 of the body 104 via an adhesive.

The method may also include infiltrating a matrix material (not shown) in, on, and/or about at least a portion of the body 104, the designed textile 218, the textile layers 216, 217, 219, the face plate 106, the sole plate 108, or any combination thereof. The matrix material 220 may be disposed through one or more of the textile layers 216, 217, 219, the designed textile 218, or a combination thereof. For example, the matrix material may penetrate or migrate from an outer surface of the designed textile 218 to and through the designed textile 218, the textile layers 216, 217, 219 or a combination thereof.

In at least one embodiment, infiltrating the matrix material through at least a portion of the body 104 may include a resin transfer molding (RTM) process. RTM may be a closed-mold process utilizing a mold (e.g., a matched male and female mold) prepared from a variety of materials (e.g., steel, aluminum, a composite, etc.). In an exemplary embodiment, the sacrificial core 202 along with the face plate 106, the sole plate 108, the designed textile 218, and the textile layers 216 may be disposed in the mold, and the matrix material in the form of a liquid or a melt (e.g., heated resin or thermoplastic) may be injected in the mold to coat, saturate, penetrate, or otherwise contact the designed textile 218 and the textile layers 216 to thereby form a continuous matrix. The matrix material may be cured or allowed to harden to thereby form a strong, durable composite of the body 104 including the matrix materials, the designed textile 218, and the textile layers 216. It should be appreciated that the RTM process may include variations thereof including, but not limited to, a vacuum-assisted resin transfer molding (VARTM) process. It should further be appreciated that the RTM process may be more economical and require relatively fewer operating pressures as compared to other processes, such as injection molding.

The matrix material may be or include, but is not limited to, any one or more of a polymer, a resin, a thermoplastic, a thermoset, or the like, or any combination thereof. Illustrative matrix materials may be or include, but are not limited to, an epoxy, a vinyl ester, phenolics, thermoplastic polyurethane, thermoplastic polypropylene, thermoplastic polyethylene, thermoplastic polyether ether ketone (PEEK), thermoplastic polyesters, thermoplastic polystyrenes, thermoplastic polycarbonates, thermoplastic polyvinylchlorides, nylon, thermoplastic polymethylmethacrylate, thermoset polyurea, thermoset polyurethanes, polyamides, polyketones, polyesters, copolyesters, polyphenylene sulfide, polyolefins, polyarylates, polyphenylene ethers, or the like, or any combination thereof. The matrix material 220 may be optically transparent. As used herein, the expression “optically transparent” may refer to a material having a visible transmission, as determined according to reference test ASTM D1003 of the American Society for Testing and Materials (ASTM), of from greater than or equal to about 60%, greater than or equal to about 70%, greater than or equal to about 80%, greater than or equal to about 90%, or greater than or equal to about 95% to about 100%. The matrix material may provide the club head 100 with a matte finish. The matrix material may also provide the club head 100 with a glossy finish.

The method may also include removing the body 104 of the club head 100 from the mold and removing the sacrificial core 202 from the body 104 to form a cavity 222, as illustrated in FIG. 3E. Removing the sacrificial core 202 from the body 104 may include dissolving the sacrificial core 202 with a solvent. Removing the sacrificial core 202 may also include heating the body 104 to melt the sacrificial core 202. As illustrated in FIG. 3E, the textile layers 216 may define a cavity 222 disposed in the body 104 after removing the sacrificial core 202.

In addition to the foregoing, the method may also include one or more additional steps. For example, while FIGS. 2 and 3 illustrate the hosel 110 integrally formed with the body 104, it should be appreciated that the body 104 may be fabricated without the hosel 110, and the hosel 110 may be separately coupled with the body 104. Additionally, in at least one embodiment, the face plate 106 may alternatively be coupled with the body 104 of the club head 110 after contacting the matrix material 220 with the designed textile 218 and the textile layers 216. For example, the face plate 106 may be coupled with an outer surface of the layer of the matrix material 220.

It should be appreciated that each of the steps illustrated in FIGS. 2A-2E and 3A-3E may not be required. It should further be appreciated that the order of the steps illustrated in FIGS. 2A—2E and 3A—3E are not limiting. For example, the textile layers 216, 217, 219 (e.g., carbon fiber mats) may be disposed about the sacrificial mold 202 before coupling any one or more of the weighting elements 204, 206 therewith, and the weighting elements 204, 206 may be coupled with an outer surface of the textile layers 216. Other modifications of the method are contemplated.

The golf club and/or the club head 100 described herein may provide one or more beneficial features or properties for a consumer (e.g., golfer). For example, it should be appreciated that, in at least one embodiment, the club heads 100 including the visual features 102, may be free or substantially free of metal and/or metal alloys, except for the face plate 106, the sole plate 108, and/or the weighting elements 204, 206. Particularly, the body 104 of the club head 100 may be fabricated or manufactured entirely (e.g., 100%) or substantially from carbon fiber composites (e.g., carbon fibers disposed in a matrix material). As such, the club head 100 and/or the body 104 thereof may be free or substantially free from metal fibers, metal alloy fibers, glass fibers, or the like, or any combination thereof. Fabricating the club head 100 from the carbon fiber composites may provide beneficial features and properties, such as the ability to increase size of the club head 100 while maintaining traditional club head weights. Utilizing the carbon fiber composites may also contribute to improved center of gravity, improved sound quality when impacting a golf ball, improved weight distribution, improved personalization, or the like, or any combination thereof. The visual or ornamental features 102 of the club head 100 may also provide utility. For example, the visual features 102 of the club head 100 may facilitate or reinforce brand recognition. In another example, the visual features 102 of the club head 100 may influence or determine, at least in part, whether a consumer purchases the golf club.

Utilizing the designs, principles, and methods discussed herein may allow consumers to manufacture customized golf clubs and golf club components (e.g., shaft, grip, club head) according to their respective preferences. For example, consumers may manufacture club heads 100 with any type of visual feature 102 that may be printed, painted, or otherwise disposed on the designed textile 218. The color, location, size, shape, design, texture, or the like, of the visual features 102 may be independently selected or determined by the consumer, thereby providing a more customized and improved experience for the consumer.

In at least one embodiment, a consumer may visit a website to create or select a customized golf club or club head 100. The website may include a “login” feature. The “login” feature may allow a server to associate a particular session at the website with a particular consumer. As such, the login feature may allow a consumer to identify themself to the server for the duration of a session using the website. The server may associate information obtained from the particular consumer during the session and store the information in one or more databases so that the server may later be associated with the particular consumer during subsequent sessions at the website. Data associated and saved for the particular consumer’s account may include, but is not limited to, previous builds, established measurements, personal information (e.g., height, gender, and handedness), previous designs, or the like, or any combination thereof. The login feature may also prompt a consumer to input a name and password and submit this information to the server or the database. The website may also provide a consumer with the option to create a new account or proceeding as a “guest.”

In order to customize a product, such as a club head 100, a consumer may activate a build command (e.g., a button on the website or user interface) on the website. After activating the build command, the server may provide the consumer's computer device with a web page including various command buttons corresponding to various products that may be customized, and various options for each of the products. The server may also provide an interface that allows the consumer to upload or submit a personalized design for the designed textile 218. The server may further provide an interface that allows the consumer to interact with and/or manipulate a 3-D rendered image of the golf club or a component thereof, such as the club head 100, to thereby determined the color, placement/position, size, shape, etc., of the personalized design. The server may also store stock images and designs for the consumer to select from for customization of the club head 100. In response to activating any one of the command buttons or interface buttons, the server may then act to impose the selection on the 3-D rendered image to display or illustrate the club head 100 with the customized visual features 102.

The consumer may utilize a computer or a computing system to implement any of the foregoing features of customizing the golf clubs and golf club components. The computing system may include one or more microprocessors. Illustrative computing systems may be or include, but are not limited to, a server, a personal computer, a tablet device, a smart phone device, or the like, or any combination thereof) capable of or configured to execute instructions and/or software, such as customization and design instructions or customization and design software. The computing system may include or have access to hardware, software, firmware, tangible storage media, or tangible machine-readable media that stores, implements, and/or executes the customization software, the instructions for customization, options for customization, templates for customization, designs for customization, designs of various types of clubs and components thereof, stock images, stock colors, types of materials, or the like, or any combination thereof. The computing system may be operably and/or communicably coupled with a network to facilitate or enable communication with other stored media and/or computing systems that may perform related ancillary functions. Ancillary functions may be or include, but are not limited to, additional customization features, rending of 3D images, or the like. The computing system may provide suggestions for customization based on consumer provided data or information. In at least one embodiment, programmable logic may be utilized that may execute one or more of the foregoing on a commercially available processing platform or a special purpose device. It should be appreciated that the computing system may perform any of the forgoing processes sequentially or concurrently.

While the devices, systems, and methods have been described in detail herein in accordance with certain preferred embodiments thereof, many modifications and changes therein may be affected by those skilled in the art. Accordingly, the foregoing description should not be construed to be limited thereby but should be construed to include such aforementioned obvious variations and be limited only by the spirit and scope of the following claims.

For example, in a first aspect, a first embodiment is a club head, comprising a body comprising an inner textile layer defining a cavity within the body, an outer textile layer disposed about at least a portion of the inner textile layer, a designed textile layer disposed about at least a portion of the outer textile layer, the designed textile layer comprising one or more visual features and a resin infiltrated into the inner textile layer and the outer textile layer to form a composite structure.

A second embodiment is the first embodiment, wherein the resin is infiltrated into the designed textile layer.

A third embodiment is any combination of the above embodiments, wherein the resin binds the designed textile layer to the outer textile layer and the outer textile layer to the inner textile layer.

A 4th embodiment is any combination of the above embodiments, wherein the inner and outer textile layers and the designed textile layer are saturated with the resin.

A 5th embodiment is any combination of the above embodiments, wherein the resin is selected from a material consisting of an epoxy, a vinyl ester, phenolics, thermoplastic polyurethane, thermoplastic polypropylene, thermoplastic polyethylene, thermoplastic polyether ether ketone (PEEK), thermoplastic polyesters, thermoplastic polystyrenes, thermoplastic polycarbonates, thermoplastic polyvinylchlorides, nylon, thermoplastic polymethylmethacrylate, thermoset polyurea, thermoset polyurethanes, polyamides, polyketones, polyesters, copolyesters, polyphenylene sulfide, polyolefins, polyarylates, polyphenylene ethers, or the like, or any combination thereof.

A 5th embodiment is any combination of the above embodiments, wherein the resin comprises a substantially optically transparent material.

A 6th embodiment is any combination of the above embodiments, further comprising one or more weighting elements disposed in the cavity and coupled to the inner textile layer.

A 7th embodiment is any combination of the above embodiments, further comprising a face plate coupled to a portion of the body.

An 8th embodiment is any combination of the above embodiments, further comprising a sole plate coupled to a portion of the body.

A 9th embodiment is any combination of the above embodiments, wherein the body is free or substantially free of metal and metal alloys.

A 10th embodiment is any combination of the above embodiments, wherein the inner and outer textile layers comprise a carbon fiber mat.

An 11th embodiment is any combination of the above embodiments, wherein the carbon fiber mat comprises woven carbon fibers.

A 12th embodiment is any combination of the above embodiments, wherein the inner and outer textile layers consist of carbon fibers.

A 13th embodiment is any combination of the above embodiments, wherein the inner textile layer comprises a first group of fibers and the outer textile layer comprises a second group of fibers, wherein the first group of fibers are substantially aligned with the second group of fibers.

A 14th embodiment is any combination of the above embodiments, wherein the inner textile layer comprises a first group of fibers and the outer textile layer comprises a second group of fibers, wherein the first group of fibers extend in a transverse direction to the second group of fibers.

A 15th embodiment is any combination of the above embodiments, wherein the one or more visual features are selected from the group consisting of an alignment feature, a logo, a brand name, an aesthetic pattern, artwork, an ornamental element, or any combination thereof.

In another aspect, a golf club is provided comprising the club head of any of the above embodiments and further comprising a shaft coupled to the club head and a grip coupled to the shaft.

A second embodiment is any combination of the above embodiments, wherein the shaft comprises: a shaft body comprising an inner textile layer defining a cavity within the shaft body; an outer textile layer disposed about at least a portion of the inner textile layer; a designed textile layer disposed about at least a portion of the outer textile layer, the designed textile layer comprising one or more visual features; and a resin infiltrated into the inner textile layer, the outer textile layer and the designed textile layer to form a composite structure.

A third embodiment is any combination of the above embodiments, wherein the grip comprises a grip body comprising an inner textile layer defining a cavity within the shaft body; an outer textile layer disposed about at least a portion of the inner textile layer; a designed textile layer disposed about at least a portion of the outer textile layer, the designed textile layer comprising one or more visual features; and a resin infiltrated into the inner textile layer, the outer textile layer and the designed textile layer to form a composite structure.

In another aspect, a first embodiment is a method for fabricating a club head comprises preparing a sacrificial core; disposing an inner textile layer around the core; disposing an outer textile layer around at least a portion of the inner textile layer; disposing a designed textile layer around at least a portion of the outer textile layer, the designed textile layer comprising one or more visual features; and infiltrating the inner and outer textile layers with a resin to form a composite structure.

A second embodiment is the first embodiment, further comprising suturing the inner and outer textile layers with the resin.

A third embodiment is any combination of the above embodiments, further comprising coupling one or more weighting elements to the sacrificial core.

A 4^{th} embodiment is any combination of the above embodiments, further comprising removing the sacrificial core from the club head.

A 5^{th} embodiment is any combination of the above embodiments, further comprising injecting a curable resin into a mold cavity under pressure to impregnate the inner and outer textile layers; and curing the resin to form the composite body.

A 6^{th} embodiment is any combination of the above embodiments, further comprising coupling a face plate to the inner textile layer.

A 7^{th} embodiment is any combination of the above embodiments, further comprising coupling a sole plate to the inner textile layer.

An 8^{th} embodiment is any combination of the above embodiments, wherein the club head is free or substantially free of metal and metal alloys.

A 9^{th} embodiment is any combination of the above embodiments, wherein the inner and outer textile layers comprise a carbon fiber mat.

A 10^{th} embodiment is any combination of the above embodiments, wherein the carbon fiber mat comprises woven carbon fibers.

An 11^{th} embodiment is any combination of the above embodiments, wherein the inner and outer textile layers consist of carbon fibers.

A 12^{th} embodiment is any combination of the above embodiments, wherein the one or more visual features of the designed textile layer comprises one or more of an alignment feature, a logo, a brand name, an aesthetic pattern, artwork, an ornamental element, or any combination thereof.

A 13^{th} embodiment is any combination of the above embodiments, wherein the inner textile layer comprises a first group of fibers and the outer textile layer comprises a second group of fibers, wherein the first group of fibers extend in a transverse direction to the second group of fibers.

A 14^{th} embodiment is any combination of the above embodiments, wherein the inner textile layer comprises a first group of fibers and the outer textile layer comprises a second group of fibers, wherein the first group of fibers are substantially aligned with the second group of fibers.

What is claimed is:

1. A club head, comprising:
a body comprising:
an inner textile layer defining a cavity within the body;
an outer textile layer disposed about at least a portion of the inner textile layer;
a designed textile layer disposed about at least a portion of the outer textile layer, the designed textile layer comprising one or more visual features; and
a resin infiltrated into the inner textile layer and the outer textile layer to form a composite structure.

2. The club head of claim 1, wherein the resin is infiltrated into the designed textile layer.

3. The club head of claim 2, wherein the resin binds the designed textile layer to the outer textile layer and the outer textile layer to the inner textile layer.

4. The club heat of claim 3, wherein the inner and outer textile layers and the designed textile layer are saturated with the resin.

5. The club head of claim 1, wherein the resin is selected from a material consisting of an epoxy, a vinyl ester, phenolics, thermoplastic polyurethane, thermoplastic polypropylene, thermoplastic polyethylene, thermoplastic polyether ether ketone (PEEK), thermoplastic polyesters, thermoplastic polystyrenes, thermoplastic polycarbonates, thermoplastic polyvinylchlorides, nylon, thermoplastic polymethylmethacrylate, thermoset polyurea, thermoset polyurethanes, polyamides, polyketones, polyesters, copolyesters, polyphenylene sulfide, polyolefins, polyarylates, polyphenylene ethers, or the like, or any combination thereof.

6. The club head of claim 1, wherein the resin comprises a substantially optically transparent material.

7. The club head of claim 1, further comprising one or more weighting elements disposed in the cavity and coupled to the inner textile layer.

8. The club head of claim 1, further comprising a face plate coupled to a portion of the body.

9. The club head of claim 1, further comprising a sole plate coupled to a portion of the body.

10. The club head of claim 1, wherein the body is free or substantially free of metal and metal alloys.

11. The club head of claim 1, wherein the inner and outer textile layers comprise a carbon fiber mat.

12. The club head of claim 11, wherein the carbon fiber mat comprises woven carbon fibers.

13. The club head claim 1, wherein the inner and outer textile layers consist of carbon fibers.

14. The club head of claim 1, wherein the inner textile layer comprises a first group of fibers and the outer textile layer comprises a second group of fibers, wherein the first group of fibers are substantially aligned with the second group of fibers.

15. The club head of claim 1, wherein the inner textile layer comprises a first group of fibers and the outer textile layer comprises a second group of fibers, wherein the first group of fibers extend in a transverse direction to the second group of fibers.

16. The club head of claim 1, wherein the one or more visual features are selected from the group consisting of an alignment feature, a logo, a brand name, an aesthetic pattern, artwork, an ornamental element, or any combination thereof.

17. A golf club comprising the club head of claim 1, and further comprising a shaft coupled to the club head and a grip coupled to the shaft.

18. The golf club of claim 17, wherein the shaft comprises:
a shaft body comprising:
an inner textile layer defining a cavity within the shaft body;
an outer textile layer disposed about at least a portion of the inner textile layer;
a designed textile layer disposed about at least a portion of the outer textile layer, the designed textile layer comprising one or more visual features; and
a resin infiltrated into the inner textile layer, the outer textile layer and the designed textile layer to form a composite structure.

19. The golf club of claim 17, wherein the grip comprises:
a grip body comprising:
an inner textile layer defining a cavity within the grip body;
an outer textile layer disposed about at least a portion of the inner textile layer;
a designed textile layer disposed about at least a portion of the outer textile layer, the designed textile layer comprising one or more visual features; and
a resin infiltrated into the inner textile layer, the outer textile layer and the designed textile layer to form a composite structure.
